(19) United States
(12) Patent Application Publication
(10) Pub. No.: US 2012/0090114 A1
(43) Pub. Date: Apr. 19, 2012

(54) Electrical Terminal Connector Cleaning Device and Method

(75) Inventors: Jack Edward Keefe, Sanford, FL (US); Robert Wesley Robinson, Longwood, FL (US); George B. Waites, JR., Fletcher, NC (US); Glenna Fay Robinson, Longwood, FL (US)

(73) Assignee: DESIGN DECISIONS, LLC, Sanford, FL (US)

(21) Appl. No.: 13/272,425

(22) Filed: Oct. 13, 2011

Related U.S. Application Data
(60) Provisional application No. 61/392,817, filed on Oct. 13, 2010.

(51) Int. Cl. B08B 1/00

(52) U.S. Cl. 15/105

(57) ABSTRACT

An electrical connector cleaning devices includes a first elongate cleaning element extending outwardly from a housing, wherein the first cleaning element includes raised surface portions extending radially outward from its outside wall surface. A second elongate cleaning element extends outwardly from the housing and includes raised surface portions extending radially inward from its inside wall surface. Each of the first and second cleaning elements is a cylindrical tube having a longitudinally extending open seam forming a gap for permitting a flexing of the cleaning element walls through a biasing force placed thereon. Each of the raised surface portions forms rings extending around the inside and outside wall surfaces of the first and second cleaning elements, respectively. One ring has its raised surface portions angularly offset along the longitudinal direction from an adjacent raised surface portion in an adjacent ring of raised surface portions.

### CROSS REFERENCE TO RELATED APPLICATION

This application claims the benefit of U.S. Provisional Application No. 61/392,817 filed Oct. 13, 2010 for Electrical Terminal Connector Cleaning Device and Method, the disclosure of which is hereby incorporated by reference herein in its entirety, and commonly owned.

### FIELD OF THE INVENTION

The present invention generally relates to electrical terminal cleaning devices and in particular to a device and method for cleaning male and female terminals typical of trailer electrical connectors.

### BACKGROUND OF THE INVENTION

As is well known in the art, and as illustrated with reference to the trailer electrical connector system disclosure of U.S. Pat. No. 6,701,566, trailer electrical connectors carry power to illuminate trailer lights, charge auxiliary batteries, and activate braking systems, by way of example. Such trailer electrical connectors generally include circular cross section male and female electrical terminals that are dimensioned to mate with one another for providing a low resistance path for electrical current flow. Due to the exposure of such trailer electrical connectors to weather, the male and female electrical terminals become covered in dirt or corrosion that results in a less than satisfactory electrical contact between the male and female electrical terminals. It is common to see owners and operators of trailers scrapping the male and female electrical terminals to remove the dirt or corrosion in order to reestablish a desired electrical contact.

As described in the above referenced patent application disclosure, devices for the cleaning of trailer electrical connectors are available, but such systems have drawbacks. For example, known devices, such as that described in U.S. Pat. Nos. 4,575,892 and 4,899,409 include brushes designed to clean terminals. Further, when a set of brushes is configured to be inserted into a female trailer connector having multiple terminals, only linear movement parallel to the longitudinal axis of the female terminals is effective. Thus, such terminal-cleaning devices are limited with regard to cleaning trailer electrical connectors having a different female terminal configuration. The plural arrangement of brushes in a cleaning device only allows for an axial linear movement, rather than both longitudinal and rotational cleaning motion. Thus, it is possible that a complete cleaning of a female terminal will not occur. Terminal cleaning devices that include brushes configured to surround the male terminals are generally only suitable for linear axial movement, and only then to clean a male trailer electrical connector having a preset number of male terminals. Brush styled terminal-cleaning devices also have an added disadvantage that when any electrical power is present on any of the male or female terminals, pieces of the brush remaining on or near the terminal after cleaning can cause a short circuit within the electrical system within which the terminal is operating.

While various other devices are well known, such as the coil configuration disclosed in the above referenced '566 patent, a need exists for a trailer electrical connector cleaning device and method that is usable with different trailer electrical connectors having different arrangements and configurations of electrical terminals, and that can be relied upon to substantially clean a terminal. The cleaning device should allow for both linear axial and rotational axial cleaning movements. There should be no concern for short circuiting between the electrical terminals of a trailer connector plug or jack. The cleaning device should be resilient. Additionally, such a device should be convenient to use and store after use.

### SUMMARY OF THE INVENTION

The present invention provides an electrical terminal cleaning device and method useful for cleaning both a towing vehicle and trailer flat four style trailer light wiring connectors, by way of example.

One embodiment according to the teachings of the present invention may comprise a first elongate cleaning element extending outwardly from a housing, wherein the first cleaning element includes a plurality of raised surface portions extending radially outward from an outside wall surface thereof, and a second elongate tubular cleaning element extending outwardly from the housing, wherein the second cleaning element includes a plurality of raised surface portions extending radially inward from an inside wall surface thereof, and wherein each of the first and second cleaning elements has a proximal end fixedly secured to the housing and opposing distal ends in a spaced relation to the housing.

Embodiment of the present invention are herein described as an electrical terminal cleaning device having a housing carrying a cleaning element for cleaning a male terminal pin and a second cleaning element for cleaning a female terminal pin. The housing may include a lighting system for illuminating a workpiece such as a trailer electrical connector and may include a cover for covering the cleaning elements when not in use. A light emitting diode (LED) may be employed to provide lighting when cleaning electrical terminals or as a convenience when looking for or inspecting the electrical connectors. Embodiments may include file like elements, herein described as raised surface portions, having edges useful in scarifying or scrapping terminal pin surfaces and thus clean typical connectors. Embodiments may include sandpaper styled elements having preselected grit surface for cleaning the connector pins. Yet further, embodiments of the invention may have its housing such that it will float in water.

### BRIEF DESCRIPTION OF THE DRAWINGS

Embodiments of the invention are described by way of example with reference to the accompanying drawings in which:

FIGS. 1 and 2 are front top side perspective views illustrating one embodiment of the present invention formed as an electrical terminal cleaning device shown in a closed and open position, respectively;

FIGS. 3 and 4 are rear top side perspective views illustrating the embodiment of FIGS. 1 and 2 in an open position, respectively;

FIG. 5 is a top of the embodiment of FIG. 1;

FIG. 6 is a cross sectional view taken through lines 6-6 of FIG. 8;

FIG. 7 is a cross sectional view taken through lines 7-7 of FIG. 5;

FIG. 8 is a side view of the embodiment of FIG. 1;

FIG. 9 is a front view of the embodiment of FIG. 1;

FIG. 10 is an exploded view of the embodiment of FIG. 1 illustrating elements carried with a housing portion thereof;

FIG. 11 is a plan view of one trailer/towing vehicle electrical connector illustrating male and female terminal connector pins;

FIGS. 12 and 13 are perspective views of one embodiment of a first cleaning element used within the embodiment of FIG. 1, by way of example;

FIGS. 14 and 15 are perspective views of one embodiment of a second cleaning element used within the embodiment of FIG. 1, by way of example;

FIGS. 16-18 are top, side and bottom views of the first cleaning element of FIG. 12;

FIG. 19 is a cross sectional view taken through lines 19-19 of FIG. 17;

FIGS. 20 is a cross sectional view taken through lines 20-20 of FIG. 16;

FIG. 20a illustrates an alternate rectangular shaped embodiment;

FIG. 21 is a cross sectional view taken through lines 21-21 of FIG. 16;

FIG. 22 is a partial view of FIG. 19;

FIG. 23 is a detail enlarged view of a portion of the embodiment illustrated in FIG. 22;

FIGS. 24 and 25 are top and side views of the embodiment of FIG. 15;

FIGS. 26 is a cross sectional view taken through lines 26-26 of FIG. 25;

FIG. 26a illustrates an alternate rectangular shaped embodiment;

FIG. 27 is a cross sectional view taken through lines 27-27 of FIG. 25;

FIGS. 28 and 29 are cross sectional views taken through lines 28-28 and lines 29-29, respectively, of FIG. 25;

FIGS. 30-33 are top perspective, bottom perspective, top and side views, respectively, for one embodiment of a lighting system carried by the embodiment of FIG. 1;

FIGS. 34-37 are top side perspective, top, side and end views of an alternate embodiment of the invention; and

FIGS. 38 and 39 are rear and front side perspective views of the embodiment of FIG. 34 in an opened position.

### DETAILED DESCRIPTION OF THE PREFERRED EMBODIMENTS

The present invention will now be described more fully hereinafter with reference to the accompanying drawings, in which embodiments of the invention are shown by way of illustration and example. This invention may, however, be embodied in many forms and should not be construed as limited to the embodiments set forth herein. Rather, these embodiments are provided so that this disclosure will be thorough and complete, and will fully convey the scope of the invention to those skilled in the art. Like numerals refer to like elements.

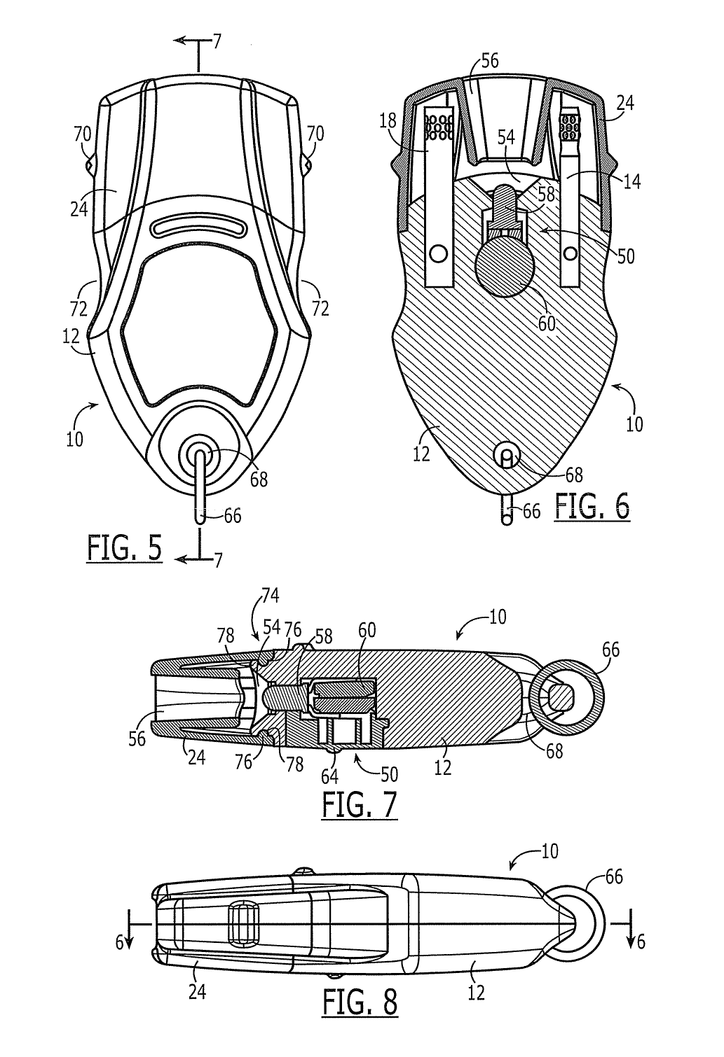

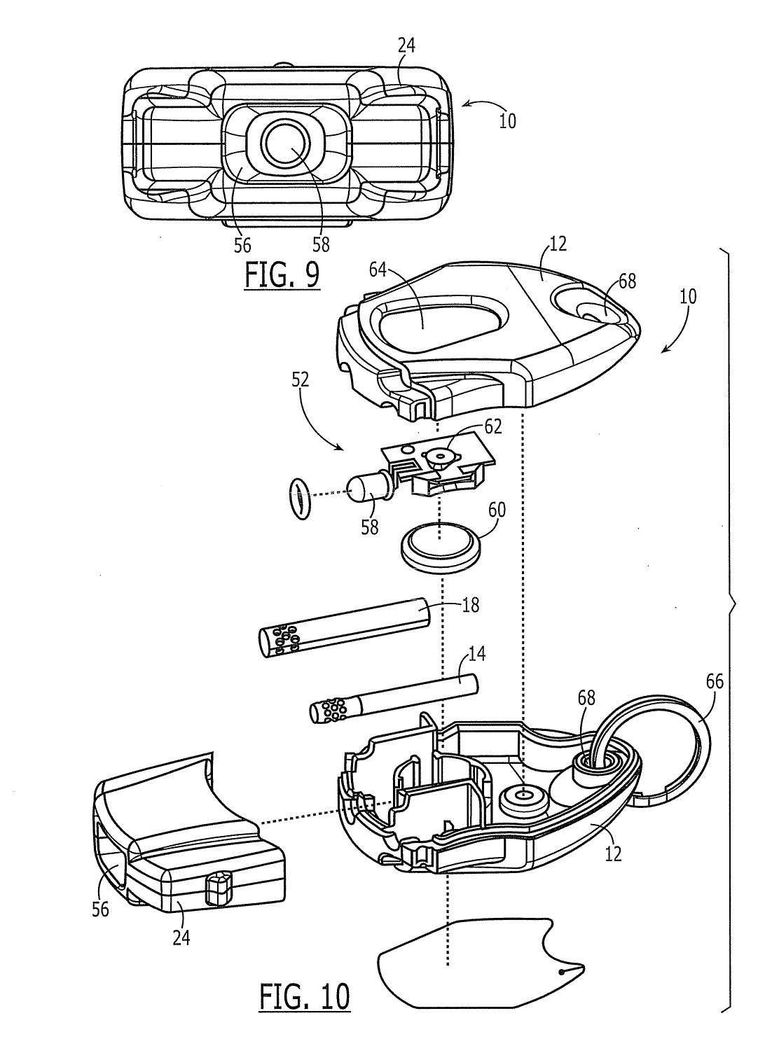

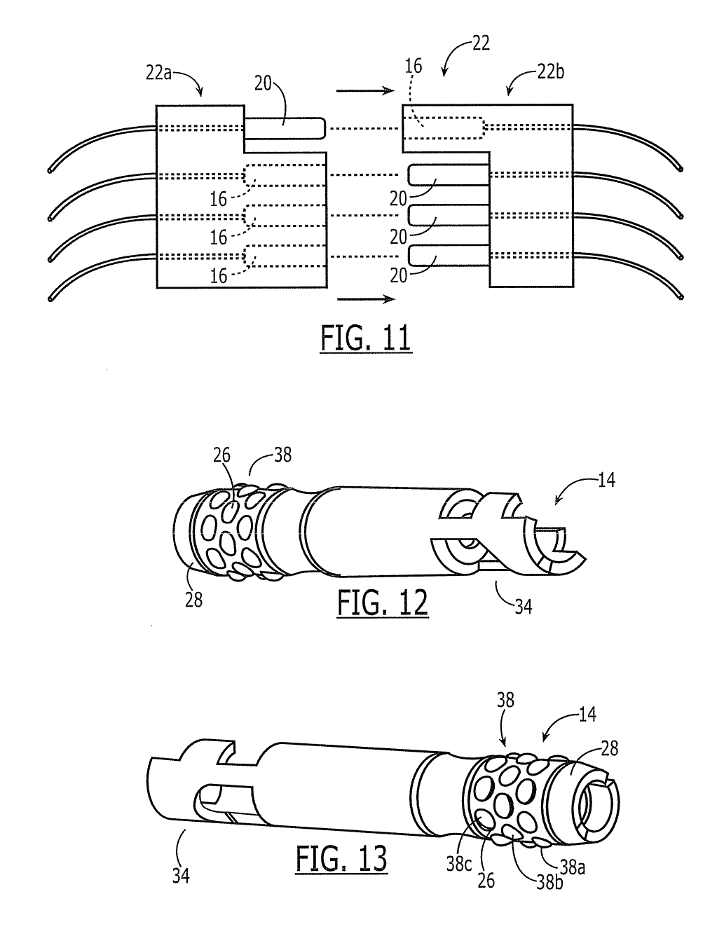

With reference to FIGS. 1-10, one embodiment of the present invention includes an electrical connector cleaning device 10 having a housing 12 that carries a first cleaning element 14 for cleaning a female electrical connector terminal pin 16 and a second cleaning element 18 for cleaning a male electrical connector terminal pin 20, of a typical trailer electrical connector 22 illustrated with reference to FIG. 11, by way of example. Both cleaning elements 14, 18 extending outwardly from the housing 12 and cylindrical in shape, by way of example, for preferred use with the connector 22 of FIG. 11. It will be understood that the connector 22 is herein presented by way of example as one typically used with trailers, but embodiments of the invention will be applicable for other electrical terminal pins and connectors.

With continued reference to FIGS. 1-10, the device 10 according to the teachings of the present invention, herein described by way of example, comprises the housing 12 carrying the cleaning elements 14, 18 and a cover 24 removably attachable to the housing for covering the cleaning elements when not in use.

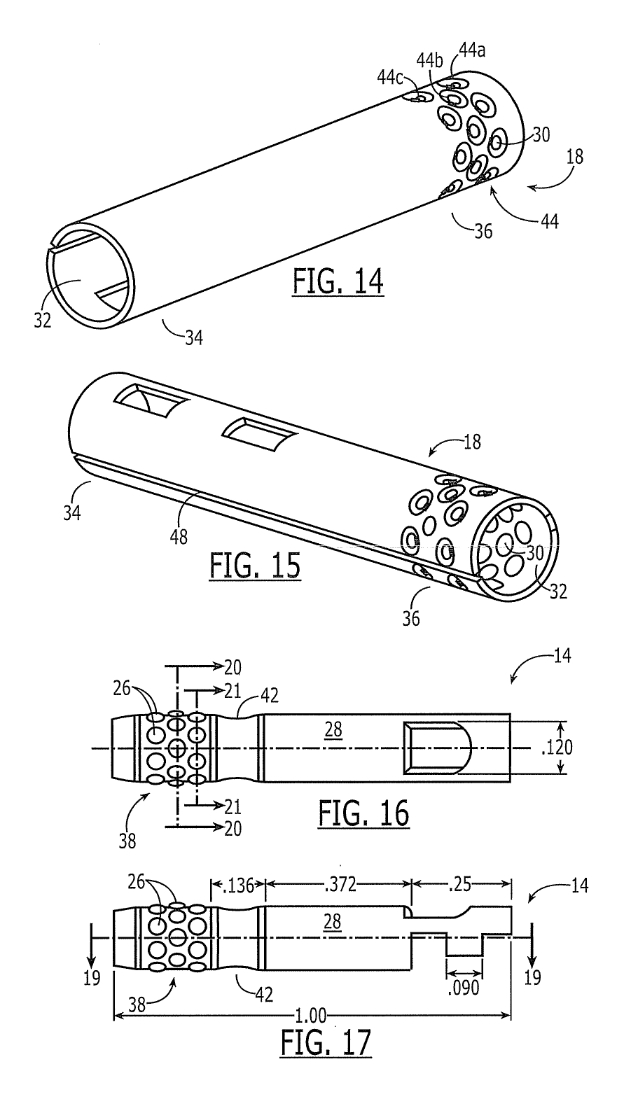

With reference now to FIGS. 12 and 13, the first cleaning element 14 is elongate, and herein tubular in shape, and includes a plurality of raised surface portions 26 extending radially outward from an outside wall surface 28. Further, the embodiments of the cleaning elements 14, 18 are herein illustrated as having a generally cylindrical structure, but it is understood that the cleaning elements may have a rectangular cross section for cleaning generally rectangular pins. As illustrated with reference to FIGS. 14 and 15, the second cleaning element 18, it too tubular in shape, includes a plurality of raised surface portions 30 extending radially inward from an inside wall surface 32. Each of the first and second cleaning elements 14, 18 has a proximal end 34 fixedly secured to the housing 12 and opposing distal ends 36 in a spaced relation to the housing. After extensive experimentation, it was determined that an effective embodiment for the cleaning elements 14, 18 included the raised surface portions 26, 30, also referred to as dimples to scrape the terminal pins 16, 20 when individually and axially rotated and longitudinally moved while contacting the pins for a desirable cleaning thereof.

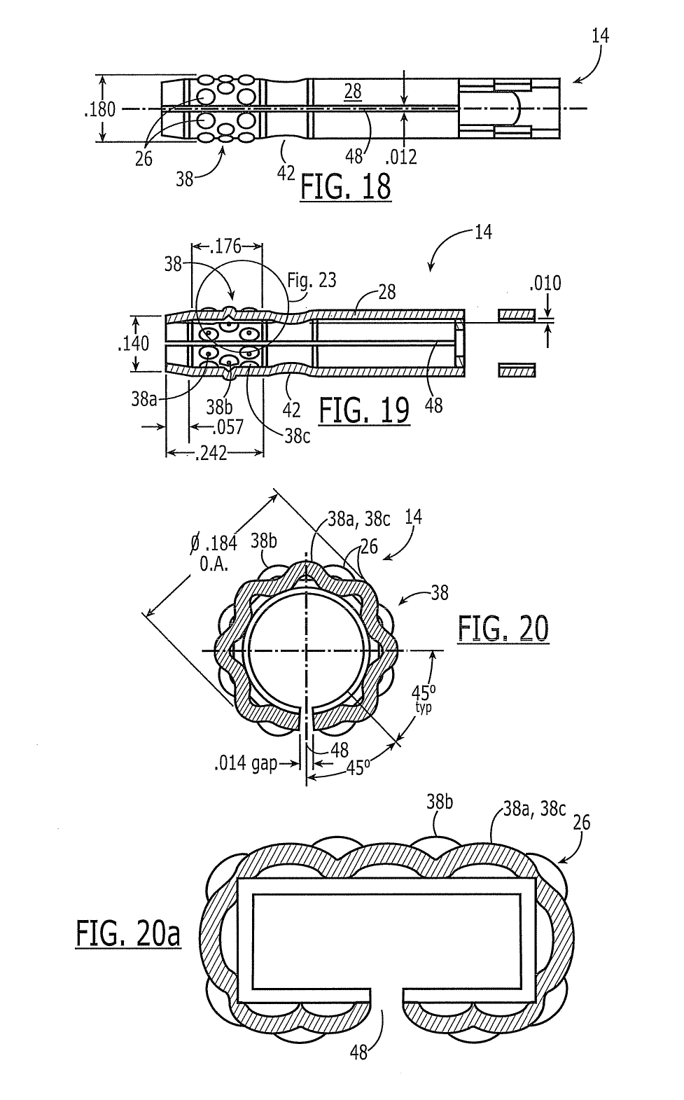

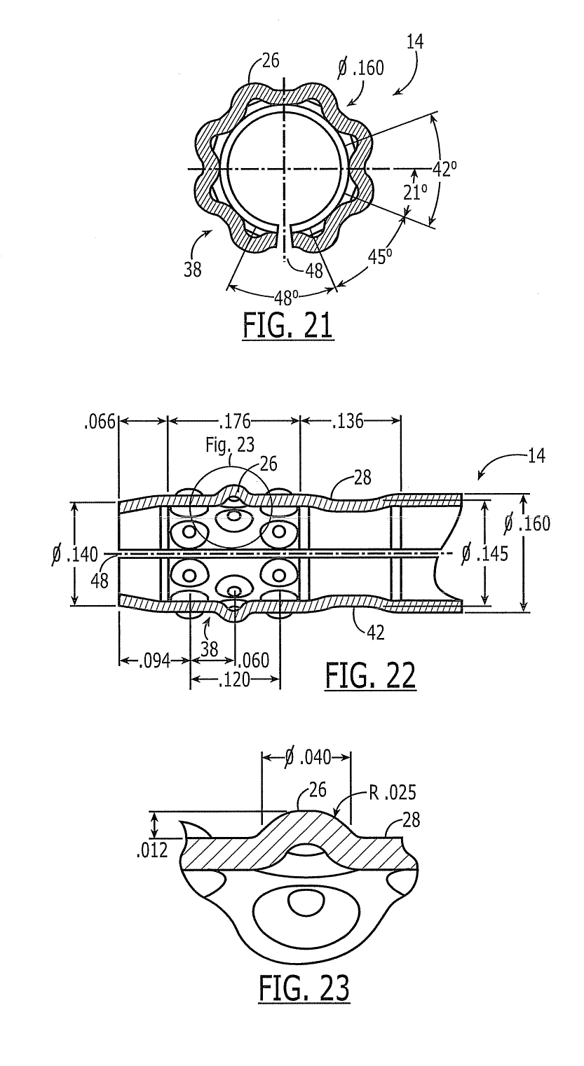

With continued reference to FIGS. 12 and 13, and with reference now to FIGS. 16-23, the raised surface portions 26 extending radially outward from the first cleaning element 14 form a first ring 38 of raised surface portions around a perimeter portion 40 of the first cleaning element. Further, the first cleaning element 14 has a recessed portion 42 extending within the outside wall surface 28 and around the perimeter portion 40 thereof. The recessed portion 42 is positioned proximate the ring 38 of the raised surface portions 26 toward the proximal end 34 thereof.

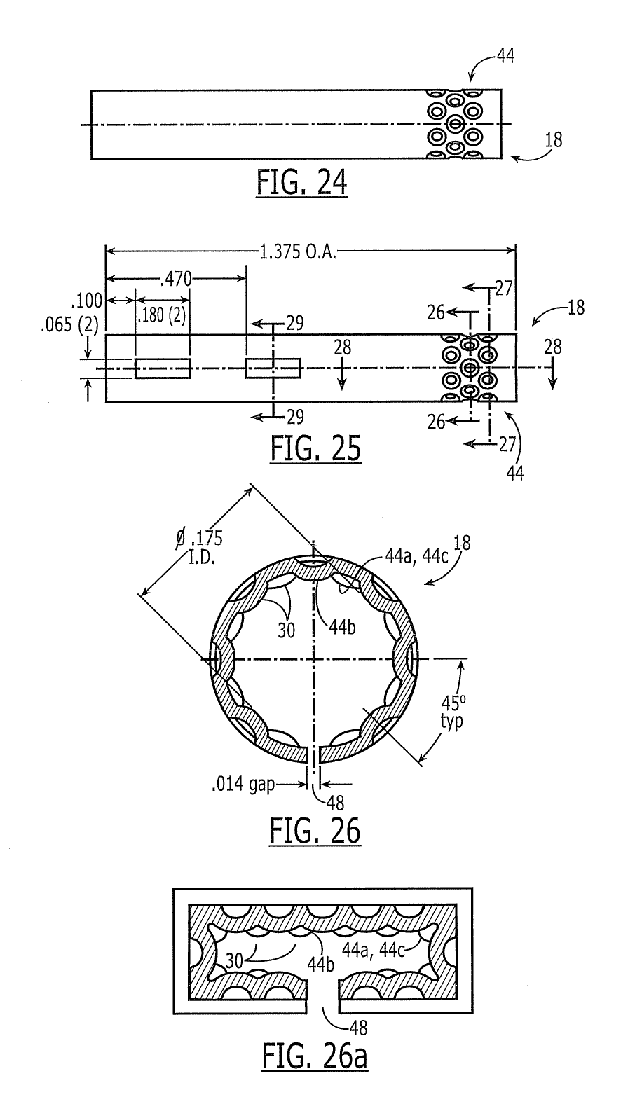

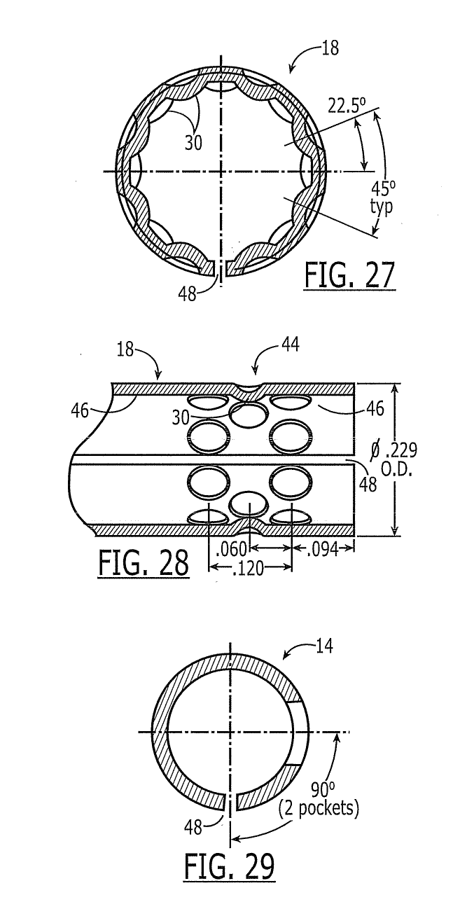

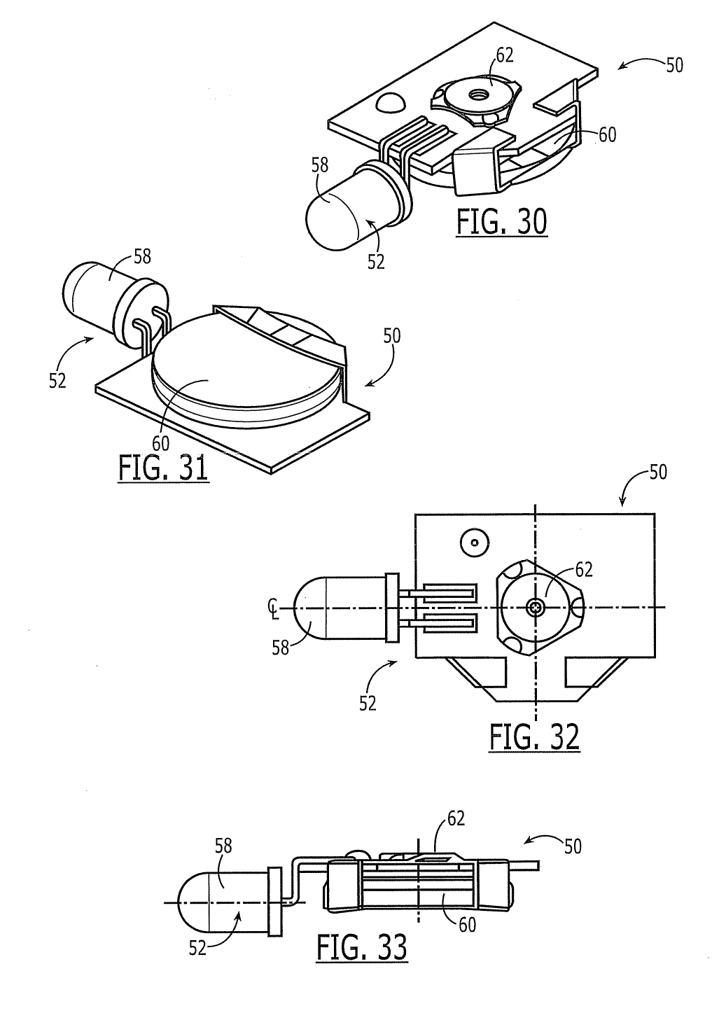

With continued reference to 14 and 15, and now to FIGS. 24-29, the plurality of raised surface portions 30 extending radially inward from the second cleaning element 18 forms a second ring 44 of the raised surface portions around the inside wall surface 32 extending around an inner perimeter portion 46 of the second cleaning element.

As herein illustrated, a plurality of rings 38a, 38b, 38c and 44a, 544b, 44c of raised surface elements extends around the inside and outside wall surfaces 28, 32 respectively, and a raised surface portion in one ring 38b, 44b of the rings is angularly offset along the longitudinal direction from an adjacent raised surface portion in adjacent rings 44a, 44c, 38a, 38c of raised surface portions. Yet further, one ring 38b, 44b positioned between adjacent other rings 44a, 44c, 38a, 38c has an odd number of raised surface portions, and the adjacent other rings have an even number of raised surface portions, as illustrated with reference to FIGS. 20 and 26, by way of example. Yet further, and as above described, the cleaning elements may have a generally rectangular cross section, as illustrated with FIGS. 20a and 26a, while including the raised surface portions as herein described.

As herein presented by way of example for one preferred embodiment of the present invention, and with reference again to FIGS. 12-15, each of the first and second cleaning elements 14, 18 is formed as a cylindrical tube. As illustrated with reference to FIGS. 15, 18-22, and 26-28 each element 14, 18 comprises an open seam 48 extending longitudinally through their respective walls. The open seam 48 forms a gap sufficient for permitting a flexing of cleaning element walls through a biasing force placed on them during an electrical terminal pin cleaning process.

With reference again to FIGS. 12-14, one preferred embodiment as herein described for the cleaning elements 14, 18 is fabricated by rolling a flat metal stock into the cylindrical tube shape while providing the gap or seam 48 along the axial direction. This provides a spring tension to the cleaning elements and allows the cleaning elements to flex when forced in close contact with the pins. The metal used in fabricating the cleaning pins is harder that the metals typically used in fabricating the electrical pins 16, 20 described earlier with reference to FIG. 11, by way of example.

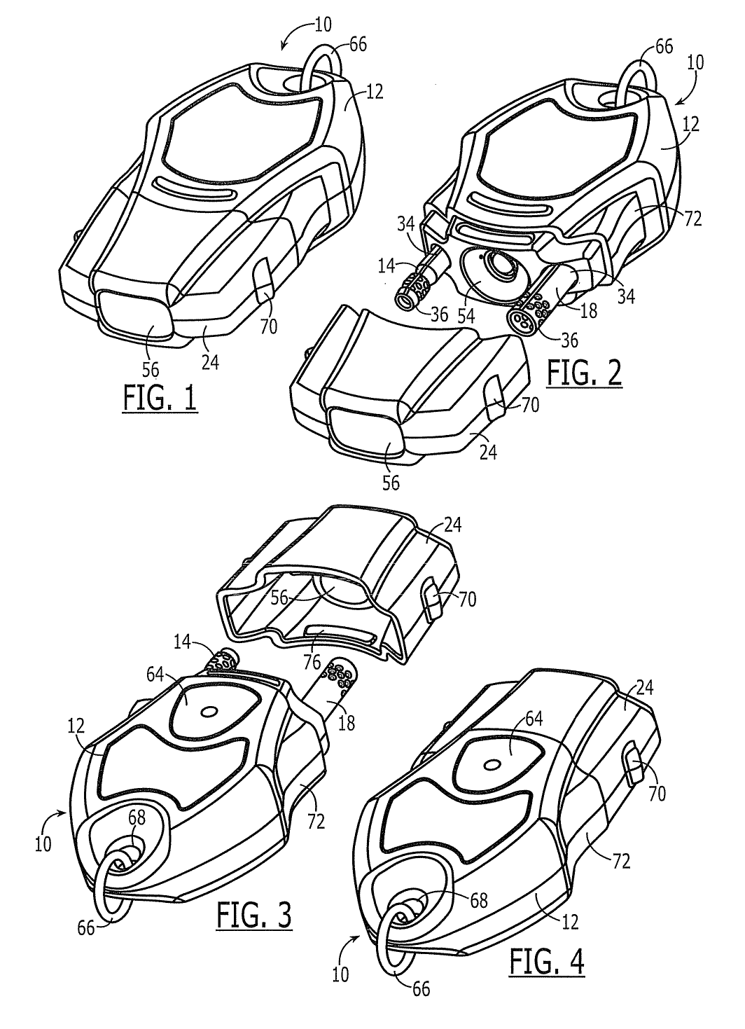

As illustrated with reference again to FIG. 2, by way of example, the first cleaning element 14 is generally parallel to and in a spaced relation to the second cleaning element 18. As illustrated with reference again to FIGS. 6 and 7, a lighting system 50 is carried in the housing 12 and directs light toward a workpiece such as the trailer terminal connector 22, described with reference to FIG. 11, when additional lighting is useful. Light from a light source 52 is directed through a first aperture 54 in the housing 12 and a second aperture 56 in the cover 24 when the cover is attached for general use of the device 10 as a utility light.

With reference to FIGS. 2, 6, 7, 9 and 10, the lighting system 50 herein described by way of example, includes an LED 58 powered by a battery 60 and operable with a switch 62 in the form of a push button, all carried by the housing 12. The push button switch 62 is positioned close to a flexible wall portion of the housing 12, thus allowing activation of the switch by depressing the flexible wall.

With reference again to FIGS. 1-8, the device may include a key ring 66 attached to a bore 68 located at an end portion of the housing 12 opposing the cover 24. For the embodiment herein described by way of example, the housing 12 and the cover 24 include tabs 70 and ridges 72 to allow ease in pulling the cover from the housing for those times when added frictional contact is desirable such as when the hands of a used may be wet, as illustrated with reference again to FIGS. 2, 3 and 5. The cover 24 is secured to the housing 12 by a snap-fit 74 arrangement using a cooperating lip 76 and groove 78, as illustrated with reference again to FIGS. 3 and 7.

While a preferred embodiment has been described above, other embodiments of the invention will come to the minds of those of ordinary skill in the art, now having the benefit of the teachings of the invention. By way of example, an embodiment of the invention may comprise a key fob styled device 80 having first and second portions 82, 84 of its housing 86 separable and connected in a snap fit arrangement. The first portion 82 carries the second cleaning element 18 within a frame 88 for receiving the three male pins 20 of the connector 22 and one first cleaning element 14 for receiving the female pins 16 of the connector portion 22a, as described with reference again to FIG. 11. The second portion 84 of the housing 86 carries three first cleaning elements 14 and one second cleaning element 18 for receiving the opposing connector portion 22b of the connector 22. As illustrated, by way of example, the second portion of the housing will thus include three first cleaning elements 14 and one second cleaning element 18.

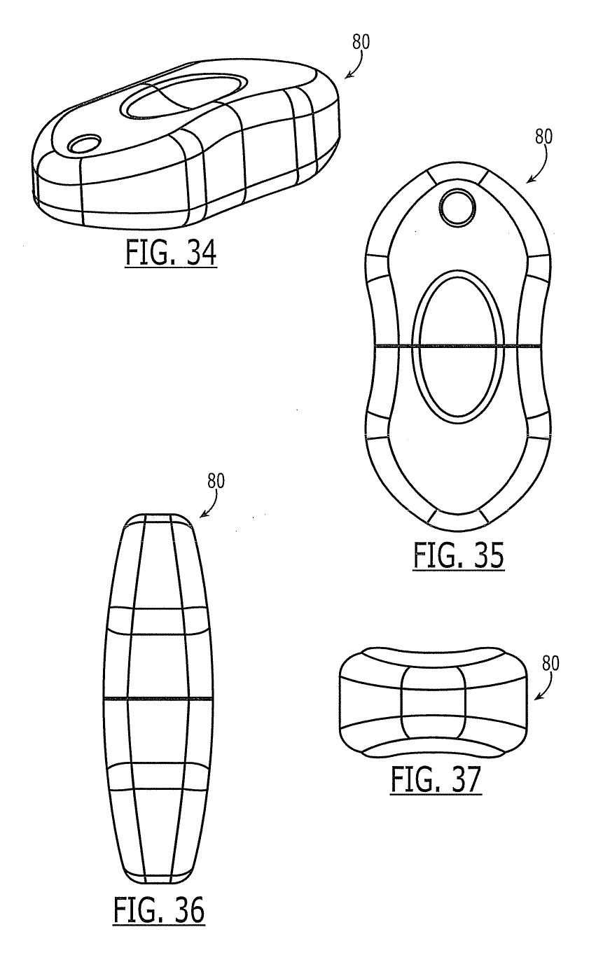

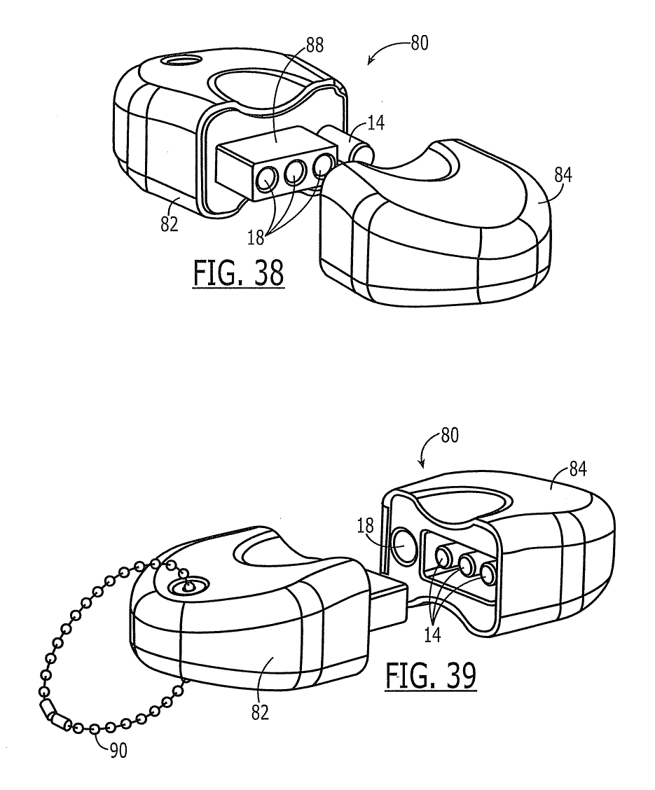

By way of further example, the cleaning elements 14, 18 may alternatively comprise wire bristles, perforated metal projections, sandpaper styled covering, or the like. For the embodiment herein described with referee to FIGS. 34-39, the cleaning motion is created by pushing and pulling the connector trailer or towing portions into and out of the appropriate housing portions. Once used, the two portions of the housing are connected in a snap fit manner where the cleaning elements are off set to allow storage within the closed housing, which housing may be carried by a key chain 90 or the like and is manufactured in such a manner so as to float.

Although the invention has been described relative to various selected embodiments herein presented by way of example, there are numerous variations and modifications that will be readily apparent to those skilled in the art in light of the above teachings. It is therefore to be understood that, within the scope of the claims hereto attached and supported by this specification, the invention may be practiced other than as specifically described.

That which is claimed is:

1. A device for cleaning electrical connectors, the device comprising:
a housing;
a first elongate cleaning element extending outwardly from the housing, wherein the first cleaning element includes a plurality of raised surface portions extending radially outward from an outside wall surface thereof; and
a second elongate tubular cleaning element extending outwardly from the housing, wherein the second cleaning element includes a plurality of raised surface portions extending radially inward from an inside wall surface thereof, and wherein each of the first and second cleaning elements has a proximal end fixedly secured to the housing and opposing distal ends in a spaced relation to the housing.

2. The device according to claim 1, wherein the first cleaning element is generally parallel to and in a spaced relation to the second cleaning element.

3. The device according to claim 1, wherein the plurality of raised surface portions extending radially outward from the first cleaning element forms a ring of raised surface portions around a perimeter of the first cleaning element.

4. The device according to claim 1, wherein the first cleaning element includes a recessed portion extending within the outside wall surface and around a perimeter thereof, the recessed portion positioned proximate the raised surface portions on a proximal side thereof.

5. The device according to claim 1, wherein the plurality of raised surface portions extending radially inward from the second cleaning element forms a ring of raised portions around an inner wall extending around an inner perimeter of the second cleaning element.

6. The device according to claim 1, wherein each of the first and second cleaning elements comprises one of a cylindrical tube and a rectangular tube.

7. The device according to claim 6, wherein each of the first and second cleaning elements comprises an open seam extending longitudinally therethrough, the open seam forming a gap sufficient for permitting a flexing of cleaning element walls through a biasing force placed thereon.

8. The device according to claim 1, wherein each of the plurality of raised surface portions of the first and second cleaning elements forms a plurality of rings of raised surface elements extending around the inside and outside wall surfaces respectively, and wherein a raised surface portion in one ring of the plurality of rings is angularly offset along the longitudinal direction from an adjacent raised surface portion in an adjacent ring of raised surface portions.

9. The device according to claim 8, wherein the plurality of rings of raised surface portions comprises at least three rings, and wherein one ring positioned between adjacent other rings has an odd number of raised surface portions, and the adjacent other rings have an even number of raised surface portions.

10. The device according to claim 1, wherein the housing comprises hollow first and second body portions joined together about peripheral edges thereof to form a cavity within the housing.

11. The device according to claim 1, further comprising a cover dimensioned to be removably secured to the housing for covering the first and second cleaning elements.

12. The device according to claim 1, further comprising a lighting system carried within the housing.

13. The device according to claim 12, wherein the lighting system comprises:
a light emitting diode (LED);
a battery; and
a switch operable with the battery and the LED for operation thereof.

14. The device according to claim 13, wherein the housing includes an aperture extending from an outside surface thereof to the LED for permitting light emitted therefrom to project outside the housing.

15. The device according to claim 14, wherein the LED is positioned between the first and second cleaning elements.

16. The device according to claim 1, wherein the housing includes a hole sufficient for receiving a key ring therethrough.

17. The device according to claim 1, wherein at least one of the first and second cleaning elements comprises multiple cleaning elements aligned in a parallel spaced relation.

18. The device according to claim 17, wherein the first multiple cleaning elements are integrally formed.

19. The device according to claim 17, wherein the first multiple cleaning elements are carried in a first portion of the housing and the second multiple cleaning element are carried in a second portion of the housing, and wherein the first and second housing portions removably fit together, wherein the first multiple cleaning portions engage the second multiple cleaning portions.

20. The device according to claim 1, wherein the first cleaning element is dimensioned for being received by and cleaning a female electrical terminal, and wherein the second cleaning element is dimensioned for receiving and cleaning a male electrical terminal through rotational and longitudinal movements thereof.

21. A device for cleaning electrical connectors, the device comprising:
a housing; and
at least one of a first elongate cleaning element and a second elongate cleaning element,
wherein the first elongate cleaning element extending outwardly from the housing, wherein the first cleaning element includes a plurality of raised surface portions extending radially outward from an outside wall surface thereof, and
wherein the second elongate tubular cleaning element extending outwardly from the housing, wherein the second cleaning element includes a plurality of raised surface portions extending radially inward from an inside wall surface thereof, and wherein each of the first and second cleaning elements has a proximal end fixedly secured to the housing and opposing distal ends in a spaced relation to the housing.

22. The device according to claim 21, wherein the plurality of raised surface portions extending radially outward from the first cleaning element forms a ring of raised surface portions around a perimeter of the first cleaning element.

23. The device according to claim 21, wherein the first cleaning element includes a recessed portion extending within the outside wall surface and around a perimeter thereof, the recessed portion positioned proximate the raised surface portions on a proximal side thereof.

24. The device according to claim 21, wherein the plurality of raised surface portions extending radially inward from the second cleaning element forms a ring of raised portions around an inner wall extending around an inner perimeter of the second cleaning element.

25. The device according to claim 21, wherein each of the first and second cleaning elements comprises one of a cylindrical tube and a rectangular tube.

26. The device according to claim 25, wherein each of the first and second cleaning elements comprises an open seam extending longitudinally therethrough, the open seam forming a gap sufficient for permitting a flexing of cleaning element walls through a biasing force placed thereon.

27. The device according to claim 21, wherein each of the plurality of raised surface portions of the first and second cleaning elements forms a plurality of rings of raised surface elements extending around the inside and outside wall surfaces respectively, and wherein a raised surface portion in one ring of the plurality of rings is angularly offset along the longitudinal direction from an adjacent raised surface portion in an adjacent ring of raised surface portions.

28. The device according to claim 27, wherein the plurality of rings of raised surface portions comprises at least three rings, and wherein one ring positioned between adjacent other rings has an odd number of raised surface portions, and the adjacent other rings have an even number of raised surface portions.
